(19) United States
(12) Patent Application Publication
(10) Pub. No.: US 2026/0325255 A1
(43) Pub. Date: Oct. 22, 2026

(54) DENTAL VALVE DEVICE HAVING A SHROUD END

(71) Applicant: Stoma Ventures, LLC, Chesterfield, MO (US)

(72) Inventor: Charles Thomas, Vero Beach, FL (US)

(21) Appl. No.: 19/186,221

(22) Filed: Apr. 22, 2025

(51) Int. Cl. A61C 1/00

(52) U.S. Cl. CPC A61C 1/0061

(57) ABSTRACT

A dental valve has a body having a tip receiving end, a shroud hose receiving end, a lumen formed between the tip receiving end and the shroud hose receiving end, and an opening formed in the body and a rotatable valve sealing body adapted to be inserted into the opening, the rotatable valve sealing body having a bore for alignment with the lumen formed between the tip receiving end and the shroud hose receiving end.

### BACKGROUND

This disclosure relates to a valve for a dental instrument and more particularly to a dental valve device having a shroud hose receiving end for preventing cross-contamination during and after a dental procedure.

During a dental procedure it is important to be able to remove saliva, blood, tooth fragments, metals, and other debris from the mouth of a patient. Removal of this matter allows a dentist to be able to perform a procedure in an unobstructed manner. Various systems or devices have been developed to remove liquid and solid materials from a mouth during a dental procedure. One device that is capable of removing saliva is known as a saliva ejector. A saliva ejector typically comprises a plastic flexible tube or tip for placement in the mouth of a patient. The saliva ejector tip is connected to a valve and the valve is connected to a tailpiece that is connected to a hose. The hose is connected to a source of vacuum. In this manner, saliva is passed or suctioned through the ejector tip, the valve, the tailpiece, and the hose to be disposed of in a sanitary manner. Once the procedure is completed, the ejector tip should be discarded and the valve should be replaced. The used valve should also be sterilized by use of an autoclave to be used again. Although it is suggested to autoclave the valve after use, it is known that use of an autoclave is hardly ever performed. In other words, a dirty valve is used over and over again with different patients. Another device that is capable of removing solid materials is a high volume evacuator system. A high volume evacuator system generally consists of a tube or tip that may be inserted into a mouth of a patient with the tube connected to a valve which is connected to a tailpiece with the tailpiece being connected to a hose or tubing that is in fluid communication with a source of vacuum. Again, in this manner, debris may be removed from the mouth of the patient. After the dental procedure, the tip is disposed of and the valve should be replaced. The used valve should also be sterilized by use of an autoclave. Once the valve is sterilized the valve may be reused in another dental procedure. However, although it is suggested to sterilize the valve after use, it is known that this suggested procedure is hardly ever followed. The valve is used over and over again with several different patients. As can be appreciated, these situations should be avoided in order to provide a patient with the safest setting as possible.

Typically after a dental procedure, when the valve is not replaced, a technician will remove the saliva ejector or the high volume evacuator and will wipe down the valve, the tailpiece, and the hose. However, there are areas of the valve, the tailpiece, and the hose that cannot be adequately cleaned and still contain contaminants that may be passed on to the next patient. The detritus that adheres to the internal surfaces of the valve can become a breeding ground for microbial contaminants. This buildup also contains microorganisms that remain in the valve system unless the valves are disassembled, the internal accumulated debris removed, and the valve sterilized. When a valve is replaced after a dental procedure a technician still needs to wipe down the tailpiece and the hose to protect against cross-contamination. However, there are certain areas of the tailpiece and the hose that cannot be adequately cleaned and will not pass a cleanliness test. As can be appreciated, it is important to prevent cross-contamination from one patient to another patient and/or dental care professionals.

Further, the saliva ejector and the high volume evacuator are used to remove liquids and debris from a mouth of a patient to prevent a patient from swallowing or aspirating liquids and debris produced during a dental procedure. Typically, when using these evacuator devices there is no back flow back into the mouth of a patient. However, there are times when back flow or a reverse flow may take place and previously removed liquids and debris may flow back into the mouth of the patient. It is also possible that if the systems are not properly maintained that fluids and debris from a previous patient may flow back into the mouth of a subsequent patient. These situations may be dangerous, are undesirable, and should be avoided.

Therefore, it would be desirable to have a dental valve that is used to prevent cross-contamination between one dental patient and another. It would also be desirable to have a dental valve that is capable of preventing against back flow. It would also be advantageous to have a dental valve that is disposable for a single use to prevent contamination.

### BRIEF SUMMARY

In one form of the present disclosure, a dental valve comprises a body having a tip receiving end, a shroud hose receiving end, a lumen formed between the tip receiving end and the shroud hose receiving end, and an opening formed in the body and a rotatable valve sealing body adapted to be inserted into the opening, the rotatable valve sealing body having a bore for alignment with the lumen formed between the tip receiving end and the shroud hose receiving end.

In another form of the present disclosure, a dental valve comprises a body having a tip receiving end, a shroud hose receiving end having an interior surface having an annular channel formed in the interior surface, a lumen formed between the tip receiving end and the shroud hose receiving end, and an opening formed in the body, and a rotatable valve sealing body adapted to be inserted into the opening, the rotatable valve sealing body having a bore for alignment with the lumen formed between the tip receiving end and the shroud hose receiving end.

In yet another form of the present disclosure, a dental valve comprises a body having a tip receiving end, a shroud hose receiving end, a shield, a tapered section between the shield and the shroud hose receiving end, a lumen formed between the tip receiving end and the shroud hose receiving end, and an opening formed in the body, and a rotatable valve sealing body adapted to be inserted into the opening, the rotatable valve sealing body having a bore for alignment with the lumen formed between the tip receiving end and the shroud hose receiving end.

The present disclosure provides a dental valve having a shroud end for preventing cross-contamination.

The present disclosure provides a dental valve that is easy to use during a dental procedure or operation for preventing cross-contamination.

The present disclosure provides a dental valve that is small, lightweight, easy to handle, easy to install, and easy to use during a dental procedure.

The present disclosure also provides a dental valve which is of simple construction and design and which can be easily employed with highly reliable results.

The present disclosure provides a dental valve device that is easy to install on and remove from a hose connected to a source of vacuum.

The present disclosure is also directed to a dental valve that does not require any special tools to attach the dental valve to a suction system.

The present disclosure provides a dental valve that may be disposable for a single use or a single dental operation.

The present disclosure is related to a dental valve device that does not require sterilization and prevents against cross-contamination.

The present disclosure is also directed to a dental valve that is made of a lightweight material such as plastic, polyethylene, and high density polyethylene or any other similar material so that the dental valve may be disposable.

The present disclosure also provides a dental valve that may have incorporated therein or coated thereon an antimicrobial agent or chemical to further prevent against cross-contamination when using the dental valve.

The present disclosure is related to a dental valve device that may be constructed of plastic that is recyclable or biodegradable to reduce the cost of the dental valve device and to allow the dental valve device to be disposable and discarded after a single use.

These and other advantages of the present disclosure will become apparent after considering the following detailed specification in conjunction with the accompanying drawings, wherein:

### BRIEF DESCRIPTION OF THE DRAWINGS

FIG. 1 is a perspective view of a dental valve constructed according to the present disclosure and connected to a section of suction hosing;

FIG. 2 is a perspective view of the dental valve constructed according to the present disclosure with a turret removed from the dental valve with the dental valve shown being attached to an O-ring, a tailpiece, and a hose, illustrated in an exploded orientation;

FIG. 3 is a top view of the dental valve constructed according to the present disclosure with the turret removed from the dental valve and the dental valve attached to a hose;

FIG. 4 is a cross-sectional view of the dental valve, the O-ring, the tailpiece, and the hose with the turret removed from the dental valve taken along the plane of line 4-4 in FIG. 3;

FIG. 5 is a top view of the dental valve constructed according to the present disclosure with the turret removed from the dental valve, the O-ring, the tailpiece, and the hose, illustrated in an exploded orientation;

FIG. 6 is a cross-sectional view of the dental valve, the O-ring, the tailpiece, and the hose with the turret removed from the dental valve taken along the plane of line 6-6 in FIG. 5;

FIG. 7 is a perspective view of the tailpiece constructed according to the present disclosure;

FIG. 8 is a side view of the tailpiece constructed according to the present disclosure;

FIG. 9 is a cross-sectional view of the tailpiece taken along the plane of line 9-9 in FIG. 8;

FIG. 10 is a perspective view of a rotatable valve sealing device having a check valve with the check valve shown in a closed position;

FIG. 11 is a side perspective view of the rotatable valve sealing device shown in FIG. 10;

FIG. 12 is a cross-sectional view of the rotatable valve sealing device shown in FIG. 10 taken along the plane of line 12-12; and

FIG. 13 is an exploded view of the rotatable valve sealing device.

### DETAILED DESCRIPTION OF A PREFERRED EMBODIMENT

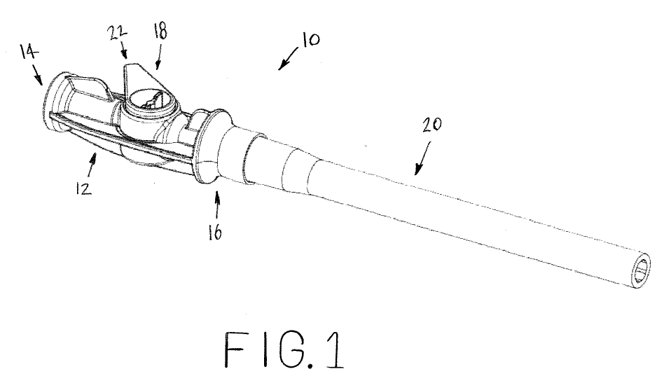

Referring now to the drawings, wherein like numbers refer to like items, number 10 identifies a dental valve for use with a dental system constructed according to the present disclosure. With reference now to FIG. 1, the dental valve 10 comprises a valve body 12 having a tip receiving end 14, a shroud hose receiving end 16, and a rotatable valve sealing body or turret 18. The tip receiving end 14 is adapted to receive an evacuator tip device (not shown) such as a saliva ejector or a high volume evacuator. The shroud hose receiving end 16 is adapted to receive a tailpiece (not shown) and a vacuum line or a hose 20 which is connected to a suction system (not shown). The device 10 may be constructed of material that allows the device 10 to be disposable and suitable for one time use. The device 10 also has a handle 22 for manual operation of the rotatable valve sealing body 18 of the device 10. Manual operation of the handle 22 will open the device 10, close the device 10, or partially open the device 10. The rotatable valve sealing body 18 may have a check valve (not shown) incorporated therein for preventing back flow, such as saliva, debris, or other fluids, into a mouth of a patient. The rotatable valve sealing body 18 will be more fully discussed herein. As can be appreciated, a suction system provides suction through an evacuator tip device, the device 10, the rotatable valve sealing body 18, a tailpiece, and the hose 20 so that any debris or saliva that is introduced into an evacuator tip device is removed through an evacuator tip device, the valve 10, the tailpiece, and the hose 20 when the rotatable valve sealing body 18 of the device 10 is in an opened state or a partially opened state.

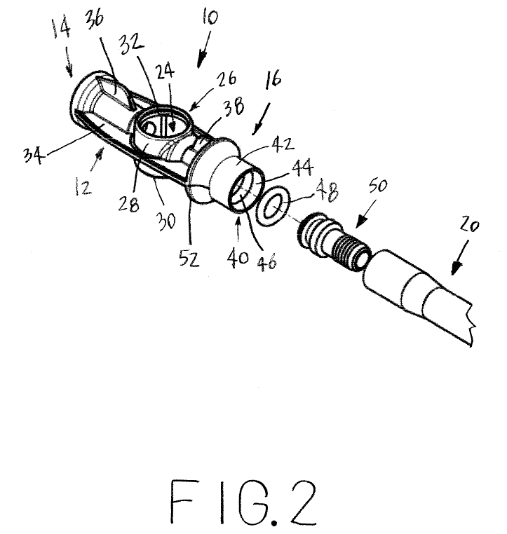

With reference now to FIG. 2, the device 10 is shown with the rotatable valve sealing device 18 being removed. The valve body 12 has a lumen 24 between the tip receiving end 14 and the shroud hose receiving end 16. The valve body 12 also has an opening 26 formed on a top side 28 of the valve body 12. The opening 26 is used to receive the rotatable valve sealing device 18 therein. A bottom portion 30 is provided in the body 12 to receive the rotatable valve sealing device 18. An annular channel or ring 32 is formed in the opening 26 which is used to retain the rotatable valve sealing device 18 in place, as will be explained in further detail herein. The device 10 has numerous ribs 34, 36, and 38 positioned about the valve body 12 to add strength to the device 10. The shroud hose receiving end 16 has a shroud hose receiving end opening 40. The shroud hose receiving end 16 also has an exterior surface 42, an interior surface 44, and an annular channel 46 formed in the interior surface 44. An O-ring 48 is used to connect the device 10 to a tailpiece 50 that is inserted into the hose 20. The O-ring 48 is adapted to fit into the annual channel 46 formed in the interior surface 44 of the shroud hose receiving end 16. The shroud hose receiving end 16 is generally cylindrical in shape and is large enough to receive therein the O-ring 48, the tailpiece 50, and a portion of the hose 20. The body 12 also has an annular shield or stop 52 formed between the shroud hose receiving end 16 and the body 12. The shield 52 is used as a surface to press against to assist in inserting the body 12 onto the tailpiece 50 and in removing the body 12 from the tailpiece 50.

FIG. 3 illustrates a top view of the dental valve 10 with the rotatable valve sealing device 18 removed from the dental valve 10 and the hose 20 inserted into the shroud hose receiving end 16. The shroud hose receiving end 16 is shown having the exterior surface 42 and the end 16 being a generally cylindrical shape. A tapered section 54 is provided between the end 16 and the shield 52. The valve body 12 also has the opening 26 formed on the top side 28 of the valve body 12. The device 10 has the ribs 34, 36, and 38 positioned about the valve body 12 and another rib 56, which is more visible in this view than the view shown in FIG. 2. The ribs 34 and 56 span between the tip receiving end 14 and the shield 52. The rib 36 spans between the tip receiving end 14 and just before the top side 28 of the valve body 12. The rib 38 spans between the shield 52 and just before the top side 28 of the valve body 12. The rib 36 is shown spanning a greater length than the rib 38. The shroud hose receiving end 16 is depicted covering the hose 20 at a juncture 58.

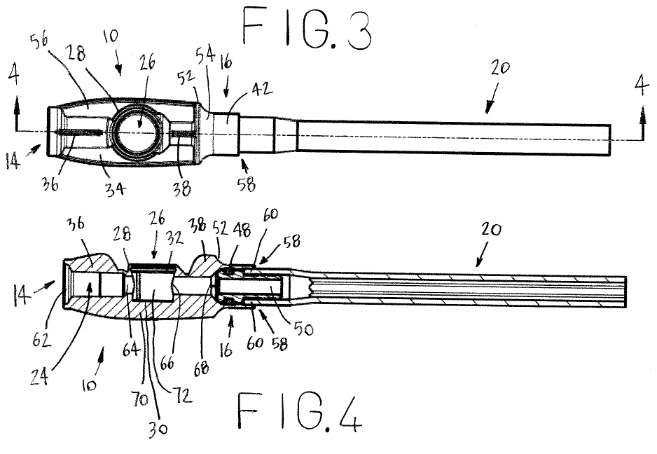

Referring now to FIG. 4, a cross-sectional view of the dental valve 10 is shown.

The dental valve 10 is connected to the hose 20 by use of the tailpiece 50. The tailpiece 50 is inserted into the hose 20 and the dental valve 10 is inserted over the tailpiece 50 and the hose 20. The O-ring 48 is also used to further secure the dental valve 10 to the tailpiece 50. A portion 60 of the hose 20 is shown being covered by the shroud hose receiving end 16 at the juncture 58. The shroud hose receiving end 16 covers the portion 60 of the hose 20 to prevent any contamination of the portion 60. This allows a technician to completely clean the hose 20 and the portion 60 after a dental procedure. The shroud hose receiving end 16 also ensures that no contaminants can reach the portion 60. The dental valve 10 also has a tip receiving end opening 62, a front or first opening 64, a back or second opening 66, and a shroud hose receiving end opening 68. The lumen 24 spans from the tip receiving end opening 62 to the shroud hose receiving end opening 68. The rib 36 spans between the tip receiving end 14 and just before the top side 28 of the valve body 12. The rib 38 spans between the shield 52 and just before the top side 28 of the valve body 12. The rib 36 is shown spanning a greater length than the rib 38. A bottom rib 70 is provided that spans between the tip receiving end 14 to the tapered section 52.

The valve body 12 also has the opening 26 formed on the top side 28. The annular channel 32 is formed in the opening 26. The body 12 has a cavity 72 into which the rotatable valve sealing body or turret 18 (FIG. 1) is inserted. The body 12 also has the bottom portion 30 adapted to receive the rotatable valve sealing device 18. The bottom portion 30 is provided for the device 18 to easily rotate and to prevent the device 18 from popping out of the body 12 during a dental procedure.

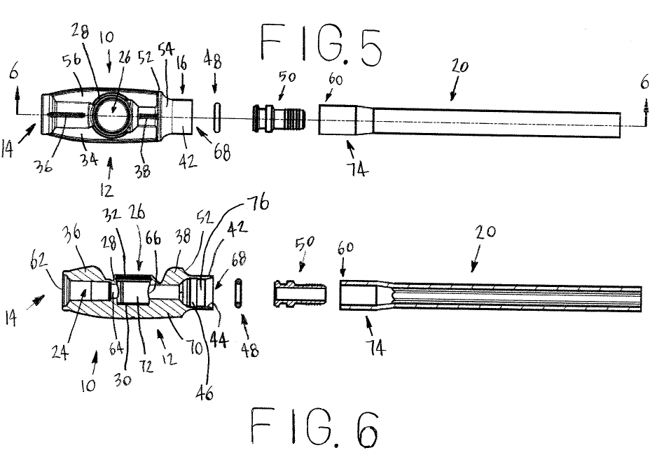

FIG. 5 illustrates a top view of the dental valve 10 with the turret 18 removed from the dental valve 10, the O-ring 48, the tailpiece 50, and the hose 20, illustrated in an exploded orientation. The hose 20 has a section 74 that is expanded due to the tailpiece 50 being inserted therein. The hose 20 also has the portion 60 that is covered by the shroud hose receiving end 16 when the dental valve 10 is connected to the hose 20. The body 12 also has the shroud hose receiving end 16 having the exterior surface 42, the tapered section 54, and the shield 52. The shroud hose receiving end 16 is generally cylindrical and has the shroud hose receiving end opening 68. The body 12 also has the ribs 34, 36, 38, and 56 which are used to strengthen the body 12. The tip receiving end 14, the opening 26, and the top side 28 are also shown.

With reference now to FIG. 6, a cross-section view of the dental valve 10 is shown. The dental valve 10 has the body 12 having the tip receiving end 14, the tip receiving end opening 62, the front or first opening 64, the back or second opening 66, the shroud hose receiving end opening 68, the shroud hose receiving end 16, and the lumen 24 which spans from the tip receiving end opening 62 to the shroud hose receiving end opening 68. The rib 36 spans between the tip receiving end 14 and just before the top side 28 of the valve body 12. The rib 38 spans between the shield 52 and just before the top side 28 of the valve body 12. The rib 36 is shown having a greater length than the rib 38. The bottom rib 70 spans between the tip receiving end 14 to the shield 52. The valve body 12 also has the opening 26 formed on the top side 28. The annular channel 32 is formed in the opening 26. The body 12 has the cavity 72 into which the rotatable valve sealing body or turret 18 (FIG. 1) is inserted. The body 12 also has the bottom portion 30 adapted to receive the rotatable valve sealing device 18. The shroud hose receiving end 16 has the exterior surface 42, the interior surface 44, and the annular channel or ring 46 adapted to receive the O-ring 48 therein. The shroud hose receiving end 16 also has another annular channel or ring 76 that is adapted to receive the tailpiece 50, as will be explained more fully herein. The shroud hose receiving end 16 is generally cylindrical in shape and the interior surface 44 is designed to receive therein the O-ring 48 and the tailpiece 50. The hose 20 has the section 74 that expands to receive therein the tailpiece 50. The hose 20 also has the portion 60 that is covered by the shroud hose receiving end 16 when the dental valve 10 is connected to the hose 20.

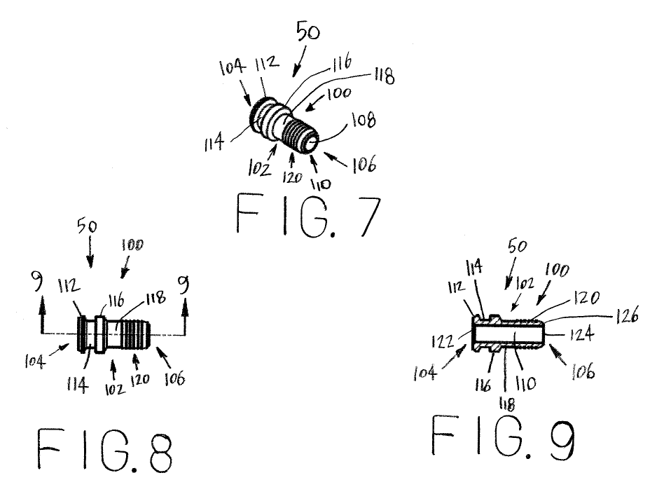

FIG. 7 illustrates a perspective view of the tailpiece 50 constructed according to the present disclosure. The tailpiece 50 comprises a body 100 having an exterior surface 102, a shroud hose receiving end 104, a hose receiving end 106, and an interior surface 108. A lumen or channel 110 is formed between the shroud hose receiving end 104 and the hose receiving end 106. The lumen 110 allows any liquid, saliva, blood, tooth fragments, or other debris to flow there through. The exterior surface 102 has a first O-ring retaining annular rib 112 positioned at the shroud hose receiving end 104. An exterior annular O-ring engaging surface 114 is provided between the rib 112 and a second O-ring retaining annular rib 116. The surface 114 is adapted to receive the O-ring 48 thereon between the rib 112 and the rib 116. The O-ring 48 is used to fit within the annular channel 46 (FIG. 6) to secure the tailpiece 50 to the device 10 (FIG. 6). A flat or smooth annular ring 118 is positioned adjacent to the second O-ring retaining annular rib 116. A series of annular retaining ribs or fins 120 are provided between the ring 118 and the hose receiving end 106. The ribs 120 are used to hold the tailpiece 50 within the hose 20 (FIG. 4). The ribs 120 may be of the same diameter.

With particular reference now to FIG. 8, a side view of the tailpiece 50 is shown. The tailpiece 50 has the body 100 having the exterior surface 102, the shroud hose receiving end 104, and the hose receiving end 106. The exterior surface 102 has the first O-ring retaining annular rib 112 positioned at the shroud hose receiving end 104. The exterior annular O-ring engaging surface 114 is provided between the rib 112 and the second O-ring retaining annular rib 116. As previously indicated, the surface 114 is adapted to receive the O-ring 48 thereon between the rib 112 and the rib 116. The flat or smooth annular ring 118 is positioned adjacent to the second O-ring retaining annular rib 116. The series of retaining ribs or fins 120 are provided between the ring 118 and the hose receiving end 106. The ring 118 is positioned between the second O-ring retaining annular rib 116 and the series of ribs 120.

FIG. 9 illustrates a cross-sectional view of the tailpiece 50. The tailpiece 50 has the body 100 having a shroud hose receiving end opening 122 at the shroud hose receiving end 104 and a hose receiving end opening 124 at the hose receiving end 106. The lumen 110 is formed between the openings 122 and 124. The exterior surface 102 has the first O-ring retaining annular rib 112 positioned at the shroud hose receiving end 104. The exterior annular O-ring engaging surface 114 is provided between the rib 112 and the second O-ring retaining annular rib 116. The flat or smooth annular ring 118 is positioned adjacent to the second O-ring retaining annular rib 116. The annular rib 116 may have a greater diameter than the annular rib 112. The series of retaining ribs 120 are provided between the ring 118 and the hose receiving end 106. The ring 118 is positioned between the second O-ring retaining annular rib 116 and the series of ribs 120. The hose receiving end 106 has a chamfered or eased section 126 which facilitates inserting the tailpiece 50 into the hose 20 (FIG. 6).

In operation of the dental device 10, the O-ring 48 is fitted onto the tailpiece 50. The hose receiving end 106 of the tailpiece 50 is inserted into the section 74 of the hose 20. Once the retaining ribs 120 firmly grip the hose 20, the shroud hose receiving end 16 is inserted onto the tailpiece 50. The O-ring 48 will be retained in the channel 46 to secure the device 10 and the tailpiece 50 together. The hose 20 is connected to a source of vacuum or a suction system (not shown). The dental valve 10 also has an evacuator tip (not shown) inserted into tip receiving end 14 of the dental valve 10. The evacuator tip may then placed in a mouth of a dental patient during a procedure to remove debris or fluids from the mouth. Once the rotatable valve sealing device 18 of the dental valve 10 is opened, air is allowed to flow through the evacuator tip, the dental valve 10, the tailpiece 50, the hose 20, and into the suction system for disposal. When suction is not needed during a dental procedure, the rotatable valve sealing device 18 of the dental valve 10 is closed. Further, once a dental procedure has been completed, the rotatable valve sealing device 18 of the dental valve 10 is closed, the valve 10, along with the evacuator tip, may be removed from the tailpiece 50, and the dental valve 10 and the tip may be discarded. A tail cap (not shown) may be inserted into the shroud hose receiving end 104 of the tailpiece 50 to further silence the suction system once the dental valve 10 has been removed from the tailpiece 50. The shroud hose receiving end 16 will cover the portion 60 of the hose 20 when the dental valve 10 is connected to the tailpiece 50 and the hose 20. In this manner, any contamination produced during a dental procedure is prevented from coming into contact with the portion 60 of the hose 20. Once the dental valve 10 has been removed from the tailpiece 50, a technician may clean or sanitize the tailpiece 50 and the hose 20. As can be appreciated, to begin a new dental procedure, the tail cap is removed from the tailpiece 50 and a new dental valve 10 is inserted or snapped into the tailpiece 50.

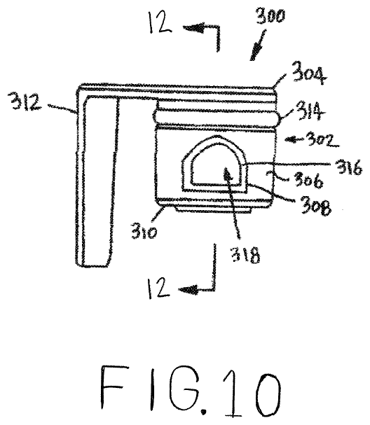

FIG. 10 is a perspective view of a rotatable valve sealing device having a check valve 300. The device 300 is capable of being inserted into the opening 26 of the valve body 12 (FIG. 2). Further, the device 300 may be the rotatable valve sealing device 18 depicted in FIG. 1. The device 300 has a rotatable valve sealing body 302 having a top 304, a central body portion 306 having a bore 308, and a bottom 310. A handle 312 is attached to or part of the top 304. The handle 312 may be the handle 22 shown in FIG. 1. The central body portion 306 also has an annular ridge portion 314 near the top 304. The ridge portion 314 is capable of fitting into the ring 32 (FIG. 2) in a snap fit engagement to secure the device 300 within the cavity 72 of the valve body 12. The bore 308 is adapted to be aligned with the lumen 24 (FIG. 2) of the valve body 12. The bore 308 of the device 300 also has a first opening 316 that is used to be aligned with the front or first opening 64 (FIG. 6) in the valve body 12. In the bore 308 is a check valve 318 positioned therein to selectively open or close the bore 308. The check valve 318 is provided for allowing liquid, saliva, or debris to pass from the tip receiving end 14, the bore 308, the check valve 318, and out the shroud hose receiving end 16 (FIG. 2) when the check valve 318 is opened. However, the check valve 318 also prevents any liquid, saliva, or debris from passing or traveling from the shroud receiving end 16, the bore 308, and through the check valve 318 when the check valve 318 is closed. The check valve 318 will close when a reduced pressure occurs from an interaction of a mouth of a patient on an evacuator tip device. For example, a patient may be requested to close the mouth of the patient around the evacuator tip device. When this occurs, a reduced pressure results in which a back flow may occur. The check valve 318 is sensitive to this pressure differential and will close to prevent back flow. The check valve 318 is shown in the closed position in FIG. 10.

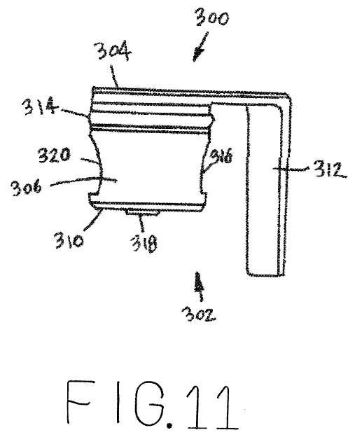

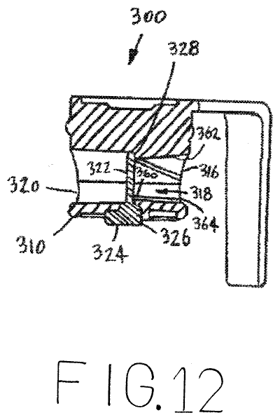

FIG. 11 illustrates a side perspective view of the rotatable valve sealing device 300. The device 300 has a second opening 320 that is used to be aligned with the back or second opening 66 (FIG. 6) of the valve body 12. The device 300 is also shown to have the rotatable valve sealing body 302 having the top 304, the central body portion 306, and the bottom 310. The handle 312 is attached to or part of the top 304. The central body portion 306 also has the annular ridge portion 314 near the top 304. The first opening 316 is also shown. The check valve 318 is further shown extending out of the bottom 310 of the device 300, as will be explained in detail further herein.

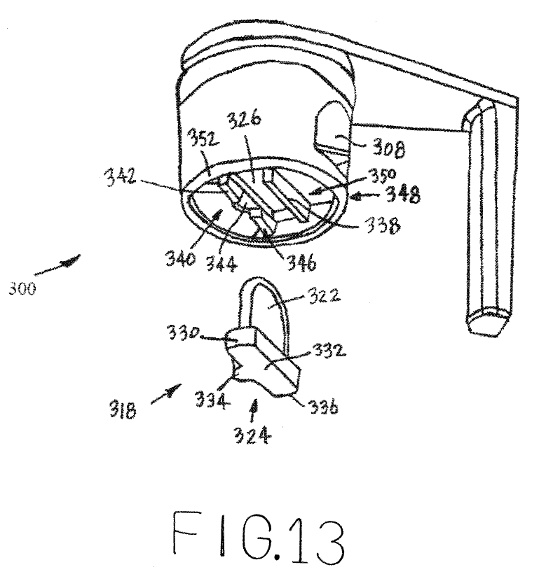

FIG. 12 shows a cross-sectional view of the rotatable valve sealing device shown in FIG. 10 taken along the plane of line 12-12. The device 300 has the bore 308 that extends through the central body portion 306 between the first opening 316 and the second opening 320. The check valve 318 comprises a flap portion 322 and a retention portion 324. The check valve 318 is inserted into the bore 308 through an opening 326 formed in the bottom 310. As can be appreciated, the check valve 318 is located within the bore 308 and offset from the first opening 316. The retention portion 324 is retained against the bottom 310. The bore 308 has an upper seat or stop portion 328 against which the flap portion 322 may be positioned when in the closed position. The upper stop portion 328 prevents the flap portion 322 from moving past a vertical position or toward the first opening 316. In this manner, when a reduced pressure occurs from an interaction of a mouth of a patient on an evacuator tip device the flap portion 322 of the check valve 318 will press against the upper stop portion 328 and prevent a back flow condition from occurring. The flap portion 322 prevents any liquid, blood, saliva, or debris present in the suction system, the hose, or the bore 308 from flowing into a mouth of a patient. The bore 308 may also be comprised having a lower seat or stop portion 360 against which the flap portion 322 may be positioned when in the closed orientation. The bore 308 has an upper slanted surface 362 that slants downward from the first opening 316 toward the upper stop portion 328. The bore 308 also has a lower slanted surface 364 that slants upwardly from the first opening 316 toward the lower stop portion 360. Also, the first opening 316 may be smaller in diameter than the second opening 320.

With reference now to FIG. 13, an exploded view of the rotatable valve sealing device 300 is shown. In this particular view, the check valve 318 has been removed from the bore 308 and the opening 326 formed in the bottom 310. The check valve 318 has the flap portion 322 and the retention portion 324. The flap portion 322 is generally hemispherical in shape. The retention portion 324 has a first end 330, a central portion 332 having an extension member 334, and a second end 336. The bottom 310 of the device 300 has the opening 326, a first ledge member 338, and a second ledge member 340 having a first ledge portion 342, a central indented ledge portion 344, and a second ledge portion 346. The central indented ledge portion 344 is for capturing the central portion 332 to retain the retention portion 324 in the bottom 310 of the device 300. The first ledge member 338 and the second ledge member 340 are also used to hold the retention portion 324 in place on the bottom 310 of the device 300. The flap portion 322 is sized and shaped to fit through the opening 326 to slide the flap portion 322 in place within the bore 308. The bottom 310 has an annular ring 348 formed in the bottom 310. A central indentation 350 is formed within the annular ring 348. The annular ring 348 has a surface 352 that contacts an interior surface (not shown) of the bottom portion 30 of the valve body 12. The annular ring 348, the central indentation 350, and the surface 352 facilitate smooth and easy rotation of the rotatable valve sealing body 302 within the valve body 12. The annular ring 348, the central indentation 350, and the surface 352 further allow rotation of the body 302 without being bound up within the valve body 12. The surface 352 may also be eased or chamfered.

The dental device 10 and the tailpiece 50 may be formed of any suitable material such as metal, plastic, polyethylene, high density polyethylene, or any other suitable material. Any suitable material may be used to construct the device 10 and the tailpiece 50 so that the device 10 and the tailpiece 50 may withstand use in a dental operation or procedure. It is also possible and contemplated to incorporate an antimicrobial agent or chemical in the device 10 and the tailpiece 50 or to provide a coating of an antimicrobial agent on the device 10 and the tailpiece 50 to further prevent cross-contamination when using the device 10 and the tailpiece 50 during a dental operation or procedure.

From all that has been said, it will be clear that there has thus been shown and described herein a dental valve having a shroud end which fulfills the various advantages sought therefore. It will become apparent to those skilled in the art, however, that many changes, modifications, variations, and other uses and applications of the subject dental valve having a shroud end are possible and contemplated. All changes, modifications, variations, and other uses and applications which do not depart from the spirit and scope of the disclosure are deemed to be covered by the disclosure, which is limited only by the claims which follow.

1: A dental valve comprising:
a body having a tip receiving end, a shroud hose receiving end having a cylindrical interior surface having an annular channel formed therein, the annular channel sized and shaped to receive an O-ring therein, a lumen formed between the tip receiving end and the shroud hose receiving end, and an opening formed in the body;
a tailpiece comprising a body having a shroud hose receiving end, a hose receiving end, a lumen formed between the shroud hose receiving end of the tailpiece and the hose receiving end of the tailpiece, an exterior surface having a first O-ring retaining annular rib positioned at the shroud hose receiving end of the tailpiece, an exterior annular O-ring engaging surface between the first O-ring retaining annular rib and a second O-ring retaining annular rib, the exterior annular O-ring engaging surface adapted to receive an O-ring thereon, and a series of annular retaining ribs between the second O-ring retaining annular rib and the hose receiving end of the tailpiece, the series of annular retaining ribs adapted to retain the tailpiece within a hose; and
a rotatable valve sealing body adapted to be inserted into the opening, the rotatable valve sealing body having a bore for alignment with the lumen formed between the tip receiving end and the shroud hose receiving end.

2: The dental valve of claim 1 wherein the shroud hose receiving end has a cylindrical exterior surface.

3: The dental valve of claim 1 wherein the shroud hose receiving end further comprises a shroud hose receiving end opening.

4: The dental valve of claim 3 wherein the shroud hose receiving end opening is sized and shaped to receive the tailpiece therein.

5: The dental valve of claim 1 wherein the rotatable valve sealing body further comprises a check valve in the bore.

6: The dental valve of claim 1 wherein the dental valve is constructed of plastic.

7: The dental valve of claim 1 wherein the rotatable valve sealing body further comprises a check valve.

8: A dental valve comprising:
a body having a tip receiving end, a shroud hose receiving end having an interior surface having a first annular channel formed in the interior surface and a second annular channel formed in the interior surface, a lumen formed between the tip receiving end and the shroud hose receiving end, and an opening formed in the body;
a tailpiece comprising a body having a shroud hose receiving end, a hose receiving end, a lumen formed between the shroud hose receiving end of the tailpiece and the hose receiving end of the tailpiece, an exterior surface having a first O-ring retaining annular rib positioned at the shroud hose receiving end of the tailpiece, an exterior annular O-ring engaging surface between the first O-ring retaining annular rib and a second O-ring retaining annular rib, the exterior annular O-ring engaging surface adapted to receive an O-ring thereon, and a series of annular retaining ribs between the second O-ring retaining annular rib and the hose receiving end of the tailpiece; and
a rotatable valve sealing body adapted to be inserted into the opening, the rotatable valve sealing body having a bore for alignment with the lumen formed between the tip receiving end and the shroud hose receiving end.

9: The dental valve of claim 8 wherein the shroud hose receiving end has a cylindrical exterior surface.

10: The dental valve of claim 8 wherein the shroud hose receiving end further comprises a shroud hose receiving end opening.

11: The dental valve of claim 10 wherein the shroud hose receiving end opening is sized and shaped to receive the tailpiece therein.

12: The dental valve of claim 8 wherein the rotatable valve sealing body further comprises a check valve in the bore.

13: The dental valve of claim 8 wherein the dental valve is constructed of plastic.

14: The dental valve of claim 8 wherein the rotatable valve sealing body further comprises a check valve.

15: A dental valve comprising:
a body having a tip receiving end, a shroud hose receiving end having a cylindrical interior surface having an annular channel formed therein, the annular channel sized and shaped to receive an O-ring therein, a shield, a tapered section between the shield and the shroud hose receiving end, a lumen formed between the tip receiving end and the shroud hose receiving end, and an opening formed in the body;
a tailpiece comprising a body having a shroud hose receiving end, a hose receiving end, a lumen formed between the shroud hose receiving end of the tailpiece and the hose receiving end of the tailpiece, an exterior surface having a first O-ring retaining annular rib positioned at the shroud hose receiving end of the tailpiece, an exterior annular O-ring engaging surface between the first O-ring retaining annular rib and a second O-ring retaining annular rib, the exterior annular O-ring engaging surface adapted to receive an O-ring thereon, and a series of annular retaining ribs between the second O-ring retaining annular rib and the hose receiving end of the tailpiece, the series of annular retaining ribs adapted to retain the tailpiece within a hose; and
a rotatable valve sealing body adapted to be inserted into the opening, the rotatable valve sealing body having a bore for alignment with the lumen formed between the tip receiving end and the shroud hose receiving end.

16: The dental valve of claim 15 wherein the shroud hose receiving end has a cylindrical exterior surface.

17: The dental valve of claim 15 wherein the shroud hose receiving end further comprises a shroud hose receiving end opening.

18: The dental valve of claim 15 wherein the rotatable valve sealing body further comprises a check valve in the bore.

19: The dental valve of claim 15 wherein the shroud hose receiving end further comprises a shroud hose receiving end opening which is sized and shaped to receive the tailpiece therein.

20: The dental valve of claim 15 wherein the rotatable valve sealing body further comprises a check valve.
